(19) United States
(12) Patent Application Publication
(10) Pub. No.: US 2019/0152309 A1
(43) Pub. Date: May 23, 2019

(54) METHODS, DEVICES AND SYSTEMS FOR POWER GENERATION

(71) Applicant: Oscar Roper, New Albany, IN (US)

(72) Inventor: Oscar Roper, New Albany, IN (US)

(21) Appl. No.: 16/133,139

(22) Filed: Sep. 17, 2018

Related U.S. Application Data
(60) Provisional application No. 62/559,226, filed on Sep. 15, 2017.

(51) Int. Cl. B60K 6/46; B60W 10/08; F01K 15/02

(52) U.S. Cl. CPC B60K 6/46; F01K 15/02; B60W 10/08

(57) ABSTRACT

The present disclosure comprises methods, systems and devices for generating energy to operate and power vehicles, vessels, trains and structures in cost-effective and energy-conserving ways.

### CROSS REFERENCE TO RELATED APPLICATIONS

This application claims priority to, the benefit under 35 U.S.C. § 119 of, and incorporates by reference herein in its entirety U.S. Provisional Patent Application No. 62/559,226, filed Sep. 15, 2017, and entitled “METHODS, DEVICES AND SYSTEMS FOR POWER GENERATION.”

### TECHNICAL FIELD

Disclosed herein are methods, devices and systems for power generation, particularly disclosed are internal combustion engines in combination with steam production and electrical generator for generating and/or storing power.

### BACKGROUND

Automobiles, including trucks, are generally powered by an internal combustion engine, though electrically powered vehicles are becoming more accepted as the costs decrease. Many vehicles realize a fuel efficiency of less than 30 miles per gallon of gasoline, and alternative fuel vehicles are thought to be an answer to achieving greater fuel efficiency. Gas-electric hybrids achieve higher fuel efficiency, but have to have battery packs to drive their electric motors. There are also fuel-cell vehicles being developed as well as electric vehicles. All electric vehicles must be charged for long periods of time and can only be driven for short distances before needing a recharge. Fuel cell vehicles have long been pursued, but are not currently widely in use because of the perceived dangers of using hydrogen fuel. Internal combustion engine-driven vehicles comprise essentially engines connected to drivetrains, which are connected to axles, which are connected to wheels. Fuel tanks and means of delivering fuel to engines are also present along with transmissions placed between the engine and the drivetrain to optimize power delivery to the wheels.

Internal combustion engines are used to provide power for many applications other than vehicles, such as stand-alone generators for providing intermittent power needs. Therefore, there is a long-felt but unresolved need for power generators that use an internal combination engine in combination with steam and electric engines to provide power for use or storage.

### BRIEF SUMMARY OF THE DISCLOSURE

Briefly described, and according to one embodiment, aspects of the present disclosure generally relate to methods for power generators that use an internal combination engine in combination with steam and electric engines to provide power for use or storage.

The present disclosure comprises methods, devices and systems for generating power. Most internal combustion engines can be retrofitted with components disclosed herein. For example, exhaust manifolds and exhaust systems can interact with disclosed components for heat exchange. For example, a device and system is shown in FIG. 1, which is an air-cooled, horizontally opposed 6 cylinder engine which can be powered initially by gasoline or may be further powered by other fuels, such as hydrogen generated on-board. The fuel source can be any known source of fuels. In summary, the internal combustion engine and its exhaust system are at least partially surrounded by boiler tubes into which water is injected, and the water is then expanded into steam by the heat from the internal combustion engine.

The steam from the heat exchange with the internal combustion engine is introduced into a steam engine, for example, a 6 cylinder rotary steam engine which is capable of generating 860 ft. lbs. of torque at 1 rpm. Used steam goes into an expansion chamber to cool and becomes liquid (water). The liquid is then collected in a reservoir to be later reintroduced into the boiler tubes. This is a closed system except for a steam expansion valve, such as a pop off valve.

Sharing a common driveshaft, a portion of the energy generated by the internal combustion engine and the steam engine is used to power a generator to make electrical energy, or be assisted by an electric motor. The entire system is designed to operate intermittently at optimal intervals. When an electric motor is not being used, the energy is stored in the lithium battery bank, or the batteries are recharged. In an aspect, connected to this system is a unit for electrolysis, to convert water into fuel grade hydrogen.

The methods, devices and systems disclosed herein may be permanently connected to a screw-type compressor which fills a compressed air tank. This tank holds and then releases compressed air that augments the pressure of the steam engine to allow for quicker start-ups and more lengthy periods of time wherein no gasoline is used to power the internal combustion engine. The system intermittently uses gasoline and intermittently uses compressed air. For example, an operator system controls the switch from gasoline use to compressed air use, and comprises computer-implemented controls and logic systems to control switching between components and initiation of each component to maximize the power available from each component.

The methods, devices and systems disclosed herein can provide electricity to power a structure, such as providing electricity to a dwelling or building. The batteries of the disclosed devices and systems may be recharged from other electrical sources, such as by the appliances of the building.

According to various embodiments, the power source of the disclosure includes an internal combustion engine that burns fuel and transmits power to a drivetrain to power the vehicle upon starting from cold. In some embodiments, after adequate steam pressure has been attained, operation of the internal combustion engine may cease and the steam engine is able to power the vehicle alone independently. In various embodiments, the disclosure includes a steam engine powered by steam generated from the heat produced by the internal combustion engine. In some embodiments, relatively superior power and thermal efficiency of the steam engine as compared to the internal combustion engine allows for augmented overall fuel efficiency and reduced emissions.

According to various embodiments, the disclosure includes a condenser to recycle the spent steam from the steam engine. In some embodiments, the steam engine receives steam from boiler tubes surrounding at least a portion of the internal combustion engine. In some embodiments, the steam engine is capable of transmitting force directly to a drivetrain and thus powering the vehicle alone after a warm-up period without the concurrent operation of the internal combustion engine. In various embodiments, the steam engine is also capable of transmitting force to an electric motor/generator that is capable of powering an air compressor. In some embodiments, the air compressor compresses air so that compressed air is stored in a tank, and such compressed air can be released to provide power. In one or more embodiments, the electric motor/generator is capable of sending electricity to and receiving electricity from one or more lithium batteries. In various embodiments, the power source of the present disclosure may further include an electrolysis unit for making hydrogen that is powered by either the electric motor/generator or by the one or more lithium batteries; wherein the hydrogen produced may be used to provide energy to the electric motor/generator. In various embodiments, the power source may be used to power a vehicle, a vessel, and/or a structure.

According to further embodiments, a method of the disclosure generating energy may include, activating the power source as described elsewhere in the disclosure. In various embodiments, a system for generating energy and power may include components as described elsewhere in the disclosure. In various embodiments, a device for moving and changing batteries may be described elsewhere in the present disclosure.

According to various embodiments, a method of the disclosure for powering a vessel, may include using a solar panel array, an electric motor and optionally, a fuel cell to provide energy for the vessel. In some embodiments, a vessel that provides its power by components may include a solar panel array, an electric motor and optionally, a fuel cell.

According to various embodiments, a method of the disclosure for powering a train, may include using one or more of a time mill, a solar panel array, a parabolic solar oven, an electric motor and a fuel cell to produce hydrogen which can be stored and used to power the electric motors of a train. In some embodiments, a train that provides power to its electric engines by hydrogen made by components may include one or more of a time mill, a solar panel array, a parabolic solar oven, an electric motor and a fuel cell.

According to various embodiments, the disclosure may include a co-generating fireplace, which includes a plurality of boiler tubes containing water, a steam engine and a condensation reservoir. In some embodiment, a method of using a co-generating fireplace to produce energy may include, heating a fuel source in the fireplace so that the heat is transferred to the boiler tubes containing water, wherein the water transforms into steam that is used to power a steam engine, and the used steam is returned to a condensation reservoir for storage as water.

According to further embodiments, a structure powered by the disclosure may include components as described elsewhere in the disclosure. In various embodiments, a time mill may be described elsewhere in the disclosure. In some embodiments, a method for making power, may include, using a time mill as described elsewhere in the disclosure. In various embodiments, a system for making power, may include, the time mill as described elsewhere in the disclosure.

These and other aspects, features, and benefits of the claimed disclosure(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a schematic of an exemplary device and system for internal combustion engines.

FIG. 2 is a schematic of an exemplary device and system for internal combustion engines.

FIG. 3 is a schematic of an exemplary device and system for internal combustion engines.

FIG. 4 is a schematic of an exemplary device and system for jet engines.

FIG. 5 is a schematic of an exemplary device and system for a pallet jack.

FIG. 6 is a schematic of an exemplary device and system for a pallet jack.

FIG. 7A is a schematic of an exemplary device and system for a container ship, whereas FIG. 7A shows the top view of a vessel.

FIG. 7B is a schematic of an exemplary device and system for a container ship, whereas FIG. 7B shows the side view of a vessel.

FIG. 8 is a schematic of an exemplary device and system disclosed herein.

FIG. 9 is a schematic of an exemplary device and system for a cogenerative fireplace.

FIG. 10 is a schematic of an exemplary device and system for a building.

FIG. 11 is a schematic of an exemplary device and system for a building.

FIG. 12 is a schematic of an exemplary device and system for a time mill.

FIG. 13 is a schematic of an exemplary device and system for a building.

FIG. 14 is a schematic of an exemplary device and system for a building.

FIG. 15 is a schematic of an exemplary device and system for a building.

FIG. 16 is a schematic of an exemplary device and system for a building.

FIG. 17 is a schematic of an exemplary parabolic solar oven that optionally may comprise one or more Fresnel lenses.

FIG. 18 is a schematic of an exemplary parabolic solar oven.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to methods for power generators that use an internal combination engine in combination with steam and electric engines to provide power for use or storage.

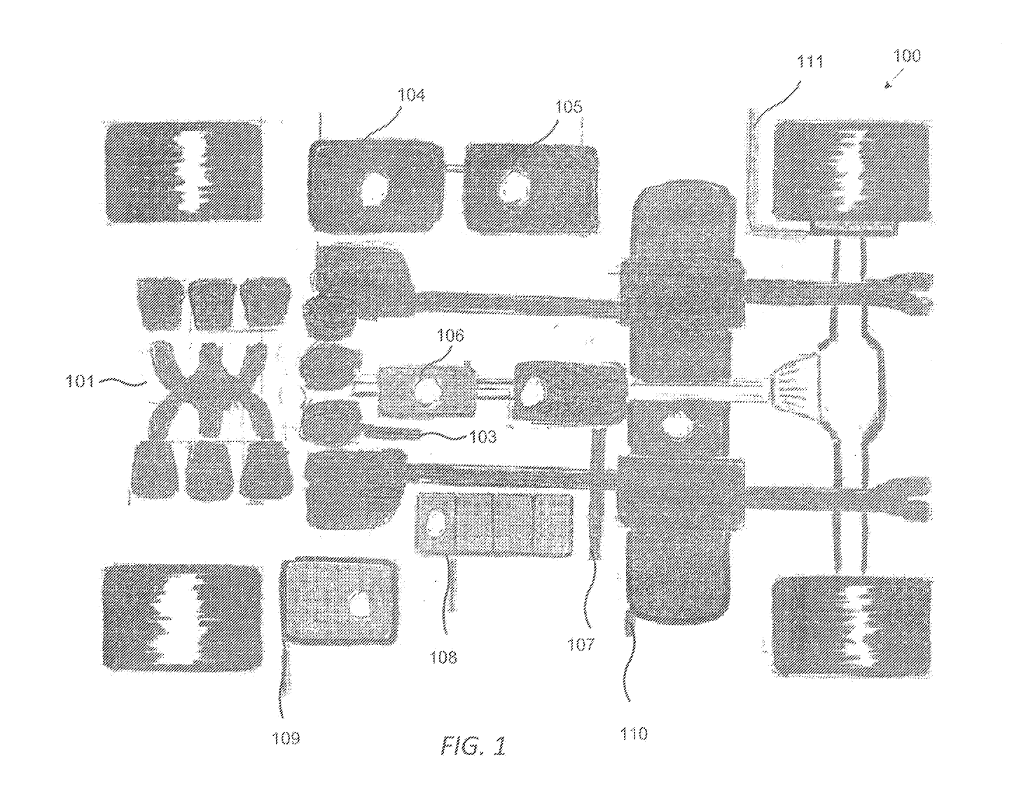

The present disclosure comprises methods, devices and systems for generating power. Most internal combustion engines can be retrofitted with components disclosed herein. For example, exhaust manifolds and exhaust systems can interact with disclosed components for heat exchange. For example, a device and system is shown in FIG. 1, which is an air-cooled, horizontally opposed 6 cylinder engine which can be powered initially by gasoline or may be further powered by other fuels, such as hydrogen generated on-board. The fuel source can be any known source of fuels. In summary, the internal combustion engine and its exhaust system are at least partially surrounded by boiler tubes into which water is injected, and the water is then expanded into steam by the heat from the internal combustion engine.

The steam from the heat exchange with the internal combustion engine is introduced into a steam engine, for example, a 6 cylinder rotary steam engine which is capable of generating 860 ft. lbs. of torque at 1 rpm. Used steam goes into an expansion chamber to cool and becomes liquid (water). The liquid is then collected in a reservoir to be later reintroduced into the boiler tubes. This is a closed system except for a steam expansion valve, such as a pop off valve.

Sharing a common driveshaft, a portion of the energy generated by the internal combustion engine and the steam engine is used to power a generator to make electrical energy, or be assisted by an electric motor. The entire system is designed to operate intermittently at optimal intervals. When an electric motor is not being used, the energy is stored in the lithium battery bank, or the batteries are recharged. In an aspect, connected to this system is a unit for electrolysis, to convert water into fuel grade hydrogen.

The methods, devices and systems disclosed herein may be permanently connected to a screw-type compressor which fills a compressed air tank. This tank holds and then releases compressed air that augments the pressure of the steam engine to allow for quicker start-ups and more lengthy periods of time wherein no gasoline is used to power the internal combustion engine. The system intermittently uses gasoline and intermittently uses compressed air. For example, an operator system controls the switch from gasoline use to compressed air use, and comprises computer-implemented controls and logic systems to control switching between components and initiation of each component to maximize the power available from each component.

The methods, devices and systems disclosed herein can provide electricity to power a structure, such as providing electricity to a dwelling or building. The batteries of the disclosed devices and systems may be recharged from other electrical sources, such as by the appliances of the building.

These and other aspects, features, and benefits of the claimed disclosure(s) will become apparent from the following detailed written description of the preferred embodiments and aspects taken in conjunction with the following drawings, although variations and modifications thereto may be effected without departing from the spirit and scope of the novel concepts of the disclosure.

### Exemplary Embodiments

Referring now to the figures, for the purposes of example and explanation of the fundamental processes and components of the disclosed systems and methods, reference is made to FIG. 1, which illustrates an exemplary, high-level overview 100 of one embodiment of the present disclosure. As will be understood and appreciated, the exemplary, high-level overview 100 shown in FIG. 1 represents merely one approach or embodiment of the present system, and other aspects are used according to various embodiments of the present system.

FIG. 1 is a schematic of an exemplary device using an internal combustion engine. Such a device can be used with any internal combustion engine and can be used with the vehicle or structure powered by the internal combustion engine. Vehicles can include, but are not limited to, cars, trucks, trains, farm equipment, construction vehicles, boats and airplanes.

FIG. 1 shows a five-way hybrid engine 100 that comprises an air-cooled, horizontally-opposed six cylinder internal combustion engine 101. Engine 101 can be powered by gasoline or by other fuels, such as hydrogen, which may be a product produced by four-way hybrid engine 100. The fuel source for engine 101 can be any known source of fuels. Internal combustion engine 101 and its exhaust system are at least partially surrounded by boiler tubes (not shown) into which water is injected, and the water is then expanded into steam by the heat from the internal combustion engine.

The steam from the heat exchange with the internal combustion engine is introduced into steam engine 103, for example, a 6 cylinder rotary steam engine which is capable of generating 860 ft. lbs. of torque @ 1 rpm. Steam exiting steam engine 103 goes to expansion chamber 104 to cool and become liquid (water). The liquid is then collected in reservoir 105. The water from reservoir 105 may be introduced into the boiler tubes that at least partially surround internal combustion engine 101 and its exhaust system. This is a substantially closed system for the steam/water, except for a steam expansion valve, such as a pop off valve (not shown).

Sharing a common driveshaft, a portion of the energy generated by internal combustion engine 101 and steam engine 103 is used to power a generator/electric motor 106 to make electrical energy, or to be assisted by electric motor. The entire system is designed to operate intermittently at optimal intervals. When electric motor 106 is not being used, the energy from steam engine 103 is stored in the lithium battery bank 108, or the batteries are recharged. In an aspect, connected to this system is electrolysis unit 109 to convert water into fuel grade hydrogen.

The methods, devices and systems disclosed herein may be connected to screw-type compressor 107 which fills compressed air tank 110. Compressed air tank 110 holds and then releases compressed air that augments the pressure of the steam engine to allow for quicker start-ups and periods of time wherein no gasoline is used to power the internal combustion engine. The system intermittently uses gasoline and intermittently uses compressed air. For example, an operator system controls the switch from gasoline use to compressed air use, and comprises computer-implemented controls and logic systems to control switching between components and initiation of each component to maximize the power available from each component. In an aspect, four-way hybrid engine 100 may comprise regenerative braking component 111 which provides energy to four-way hybrid engine 100 when the brakes are applied. Such braking systems are known in the art.

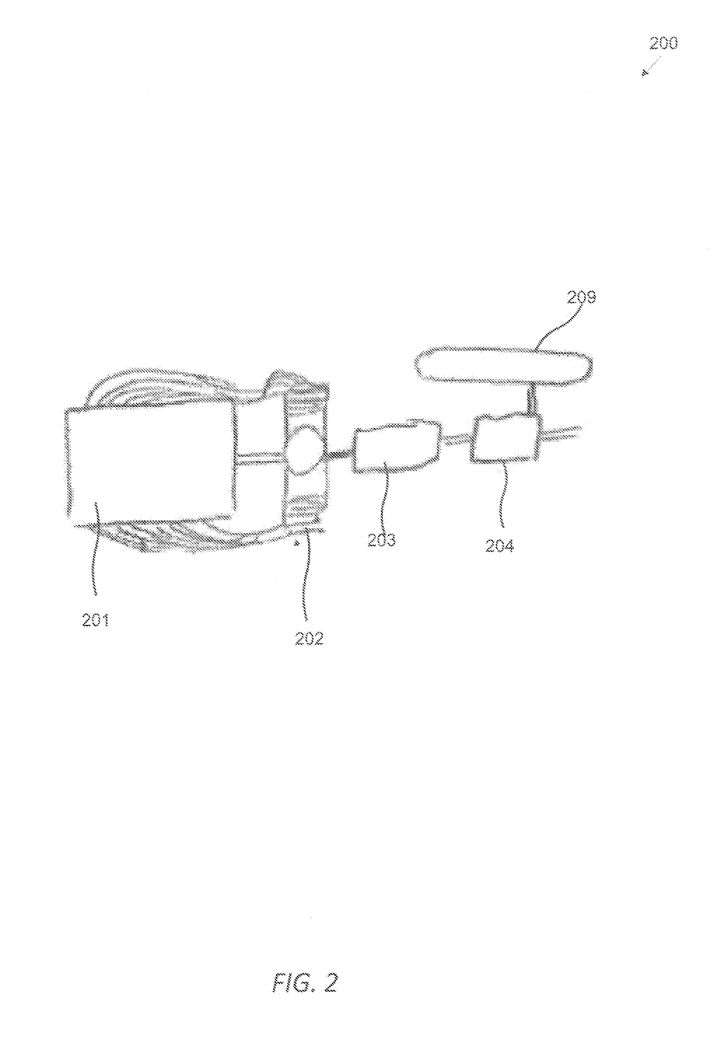

FIG. 2 shows a simplified schematic of four-way hybrid engine 200, which comprises components comprising internal combustion engine 201, steam engine 202 (which may be a rotary steam engine), electric engine/generator 203, and air compressor 204. As shown, the components of four-way hybrid engine 200 are connected in series so that heat generated by internal combustion engine 201 is transferred to water in boiler tubes to make steam that is transferred by fluid connections to steam engine 202. Steam engine 202 is connected to electric engine/electric generator 203 by energy/power conductors so that energy is produced by electric engine/electric generator 203. Electric engine/electric generator 203 is connected to air compressor 204 by energy/power conductors. Air compressor 204 is also connected via air conducting member to compressed air storage tank 209 so that compressed air or gas is available. In an aspect, air compressor 204 is also connected via energy/power connectors to the drive train system of a vehicle (not shown) such as a chain-drive mechanism or differential. Such an automotive differential is designed to drive a pair of wheels while allowing them to rotate at different speeds. In vehicles without a differential, such as karts, both driving wheels rotate at the same speed, usually on a common axle driven by a simple chain-drive mechanism. Alternatively, electric engine/electric generator 203 may be connected directly to the drive train system of a vehicle (not shown).

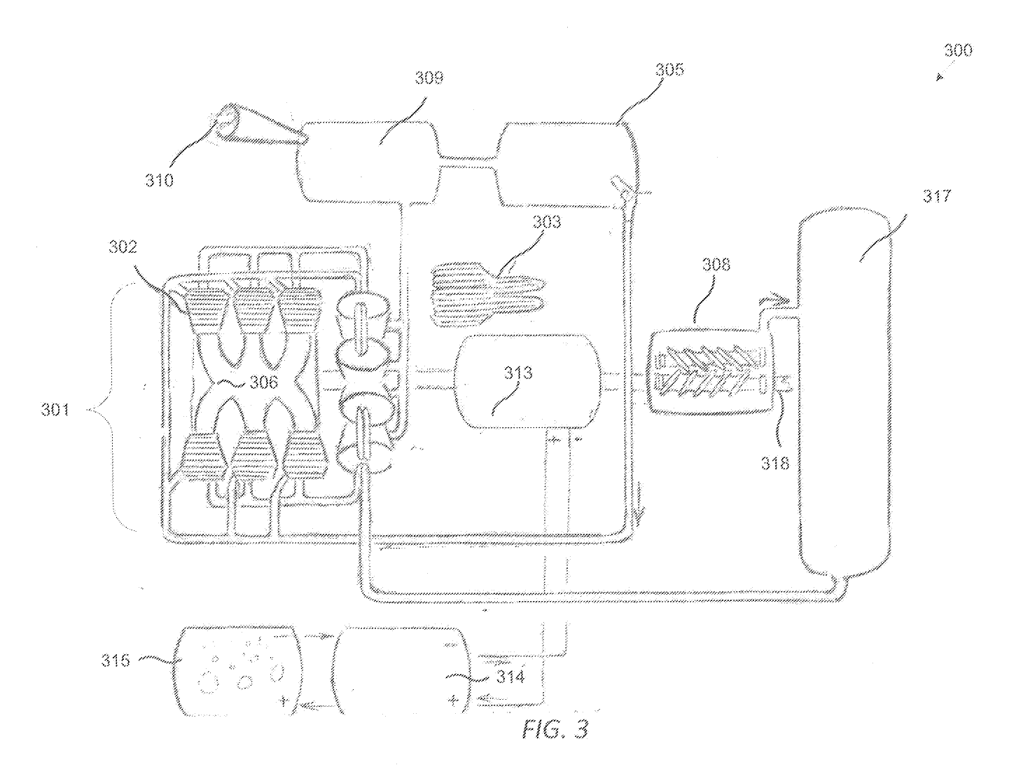

FIG. 3 shows an exemplary five-way hybrid engine 300. Control of components disclosed herein are provided by computer control components, such as a circuit board, 301, and sensors 302. Those of skill in the art can readily provide one or more controls, such as switching from one component to another, moving fluids such as air, other gases, gasoline, or water, into and out of storage components and to components using such fluids. Also known to those of skill in the art are sensors, for example, for measuring fluid levels and state changes (e.g., from liquid to gas), pressure monitors, fluid flow, temperature, etc.

The Carnot Cycle describes a hypothetical engine that is 100% efficient and was deduced by, Nicolas Carnot. The premise is that a conventional internal combustion engine produces work and everything which is not that actual work is lost in the form of waste heat and friction. Engines and methods disclosed herein capture this heat and utilize it as work. Methods, devices and systems disclosed herein comprise cooling the entire engine, block, heads and exhaust system from the outside. Disclosed methods, devices and systems can use currently used engines which can be retrofitted with boiler tubes which is similar to a locomotive engine. Thus the flow of exhaust gasses is not disrupted, or in the case of a turbocharged engine, the hot side of the turbocharger is also utilized in the methods, devices and systems comprising such boiler tubes and heat exchange.

A problem with green technologies is making them as practical and cost effective as they are useful. To date, most devices fall far short of commercial practicality. They are either too complicated, not pollution free, or cost prohibitive. It will become obvious to those skilled in the art that the energy augmentation methods, devices and systems herein disclosed can be applied to significantly improve the efficiency of any engine used to produce work.

In the engine shown in FIG. 3, the engine generates hydrogen which can be used as a fuel source for the engine. Ignition is achieved in internal combustion engine 303. For example shown in FIG. 3 is a horizontally opposed, formally air cooled 6 cylinder internal combustion engine. Once the engine is activated and is generating hear, all boiler tubes begin to heat and to transform contained fluid (e.g., water) into steam. This is confirmed by sensors 302 which interact with computer control components 301. The system is intermittent in that the most efficient mode of operation will now be automatically chosen by the computer control components 301. At optimal temperature (212-400+ degrees) water from reservoir/condenser 305 is injected into thermally efficient boiler tubes which force steam into the 6 cylinder rotary steam engine 306. This system will be augmented on demand (such as immediate maximum throttle) by compressed air tank which is filled by screw type air compressor 308. Steam and compressed air are thus utilized augmenting the efficiency of the engine to which they are applied. Exhaust steam and spent compressed air are deposited into steam/expansion chamber 309. This is a closed system with the exception of a high pressure safety pop-off valve 310 on chamber 309. Water and steam are provided in the methods, devices and systems disclosed herein through fluid connections, and compressed air is provided through fluid connections. As shown in FIG. 3, pumps 313 may be used to move fluids, including air, in the methods, devices and systems disclosed herein. Air may be compressed by air compressor 317, as shown in FIG. 3 as a screw-type compressor.

The secondary phase or electrical aspect of methods, devices and systems disclosed herein is that the operation of the engine will be also assisted by an electric motor/generator 313 which at certain select intervals, recharges lithium battery bank 314 and also converts water to hydrogen by the process commonly referred to as electrolysis in electrolysis component 315. Electric motor/generator 313 is connected to lithium battery bank 314 and electrolysis component 315 by electrical connections 316. Drive shaft 318 is connected to the engine and is used to provide power to connected components, for example, to eventually turn the wheels of a car.

What is disclosed here is a symbiosis of inveterate mechanisms which previously have not been designed to operate in concert with one another. In the event of a temporary power outage, this system can power a structure such as a home, and it is not only the powertrain for a vehicle but it is applicable across multiple power-producing systems, and even to the aerospace industry.

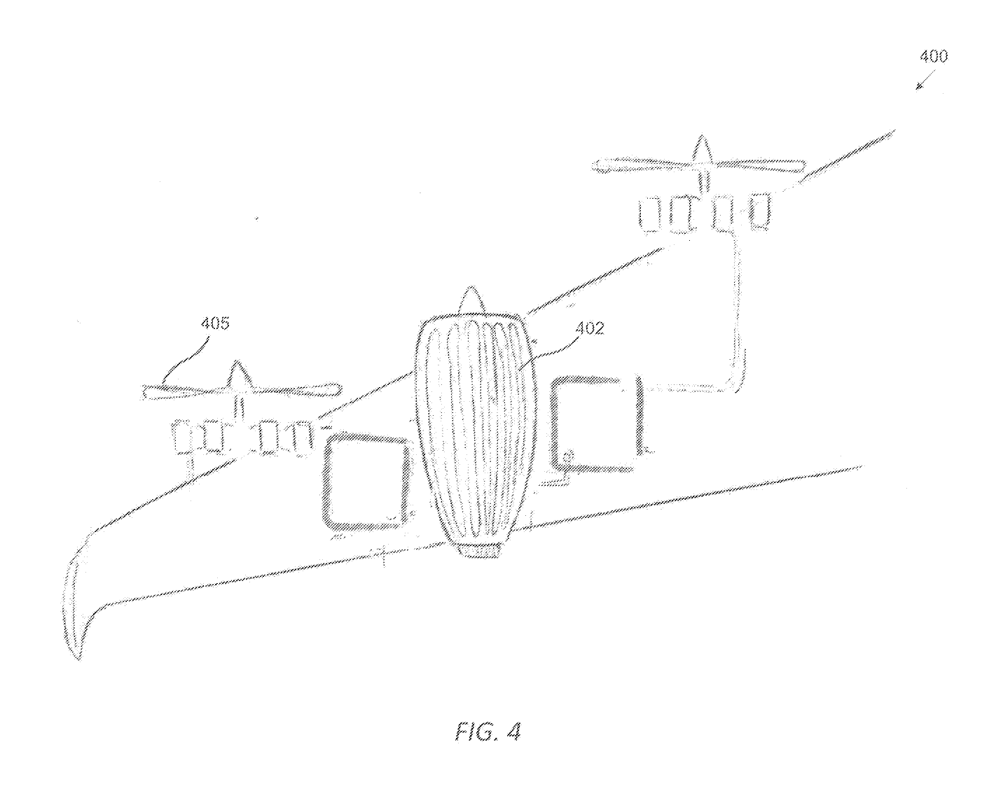

FIG. 4 shows an exemplary method, device and system using an airplane jet engine as the initiating engine. Engine 400 comprises jet engine 401 surrounded by heat exchange boiler tubes 402. The heat from jet engine 401 converts the fluid, e.g., water, in boiler tubes 402 to steam, and the steam is transported to steam engine 403 through fluid connections. Steam engine can be used for providing power to other components, for example, to turn propellers 405. Exhaust steam is return through fluid connections 404 to condensation/reservoir 405, where the steam is condensed into liquid and can be stored.

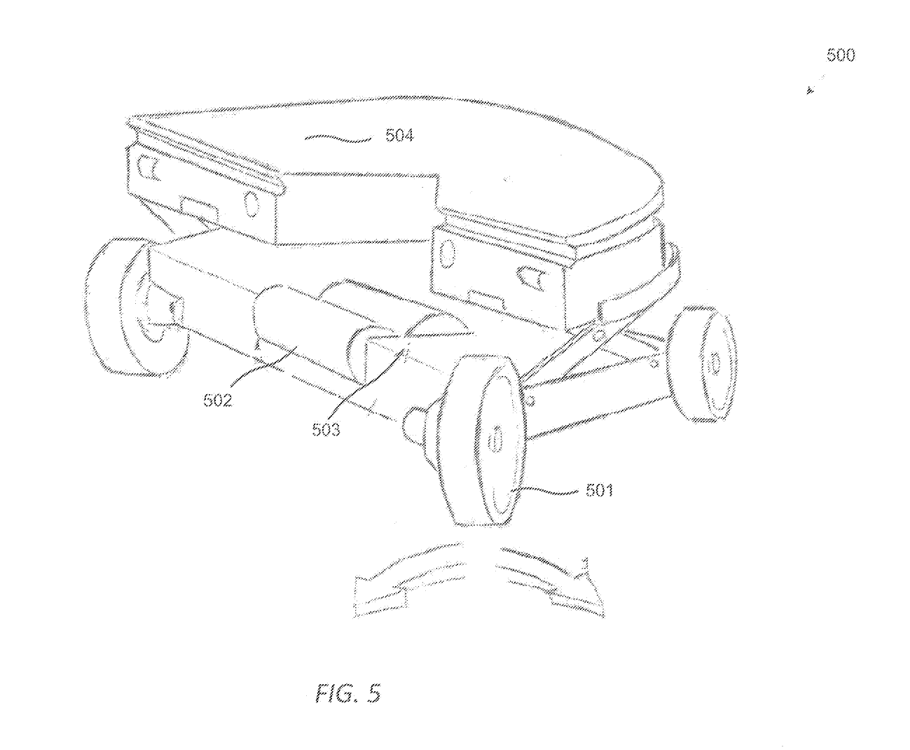

FIG. 5 shows an exemplary robotic pallet jack and battery changer 500, which may be used when changing electric batteries. A problem with existing electric vehicles is that the batteries are incorporated into the device and therefore must be plugged in to recharge, which takes a significant amount of time. With methods, devices and systems disclosed herein, the batteries can be much smaller, and with changing stations instead of charging stations, the wait is eliminated and so is the associated “range anxiety”, which refers to the worry associated with being limited to a specific distance for travel due to battery limitations. For example, batteries can be recharged at a structure in a renewable energy garage via Qi, shown in figures herein. Additionally, in an aspect, two batteries can be provided with methods, devices and systems disclosed herein so that each battery be recharged during peak sunlight and wind conditions, so that one battery is always available for a vehicle.

As exemplified herein, a battery associated with methods, devices and systems disclosed herein is lithium ion in nature. This technology being currently the most efficient until other methods are discovered, and it can be provided in a safety cocoon fabricated from carbon fiber. Two batteries are sold with each vehicle and are co-owned by user and the vehicle manufacturer/seller. A battery surcharge of a minimal amount can be added to each recharge in the field at exchanging station.

At a changing station a robotic pallet jack/battery changer 500, which is customized to fit the battery and is sensor guided, will extract a spent battery from a vehicle, gauge or measure the amount of remaining electricity to determine the spent electricity, deposit the drained battery in a charging rack, pick up a fully charged battery, affix it to the vehicle, and monitor and troubleshoot the system for any errors or concerns. Actuary tables will be set up in accordance with vehicle mileage to determine the cost of associated surcharge and older vehicles. Those with more mileage will be charged accordingly to facilitate the co-ownership.

Batteries that are currently present in a garage, for example, at a residence, can temporarily power a home and can perform this task, for example via Qi. When an automobile, comprising methods, devices and systems disclosed herein is garaged at a residence, it can temporarily power the residence via Qi, which is also its method of recharging. As used herein Qi is an open interface standard developed by the Wireless Power Consortium for inductive charging. The system uses a charging pad and a compatible device, which is placed on top of the pad, charging via resonant inductive coupling. Other types of electrical connections, such as plugs and wires, may also be used in the methods, devices and systems disclosed herein for recharging batteries.

As shown in FIG. 5, robotic pallet jack/battery changer 500 may comprise one or more wheels 501 that are moved and controlled by a drive directional motor 502. A lift motor 503 moves the battery connection platform 504 in directions, such as up and down.

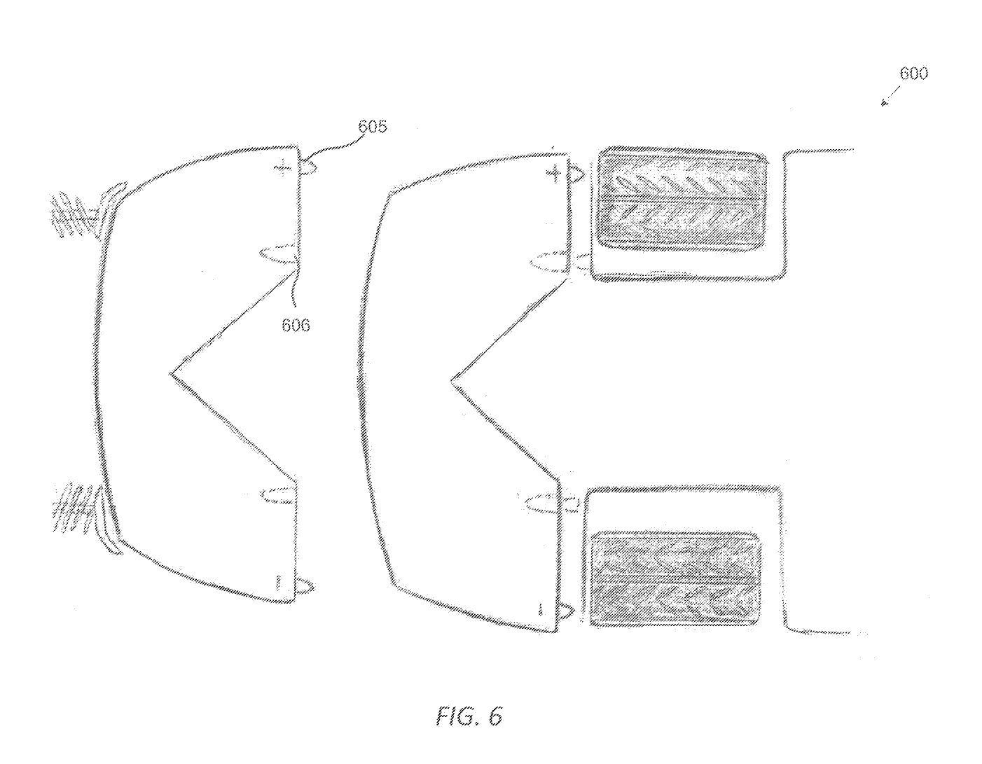

As shown in FIG. 6, battery connection platform 504 has pins 605 and indents 606 that align and mate with oppositely shaped members, pins and indents (not shown) on battery. Robotic pallet jack/battery changer 500 is moved into close association with the batteries of a vehicle so that pins 605 and indents 606 that align and mate with oppositely shaped members, pins and indents (not shown) on battery. Once aligned and mated, battery connection platform 504 moves, such as in reverse, to remove battery from the vehicle and place it in a location. In an opposite fashion, a newly charged battery (not shown) is aligned and mated with robotic pallet jack/battery changer 500 and the newly charged battery is put in the vehicle.

If the electrolysis of water could be brought about easily and in remote areas, the hydrogen produced would be invaluable to the rail industry. Another application for methods, devices and systems disclosed herein, due to the universal container, is the shipping industry or anywhere a rail vessel can be logistically utilized.

Once hydrogen is created, it can be used to produce electricity. Then this electricity can be used to directly power a locomotive or a ship which has electric motors, instead of using diesel engines. The phenomenon is thus; because electricity is used to bring about the electrolysis of water creating hydrogen, the energy held in that hydrogen can be used to create electricity. This is the manner in which many hydrogen vehicles operate. They don't actually burn the hydrogen but use it to generate electricity.

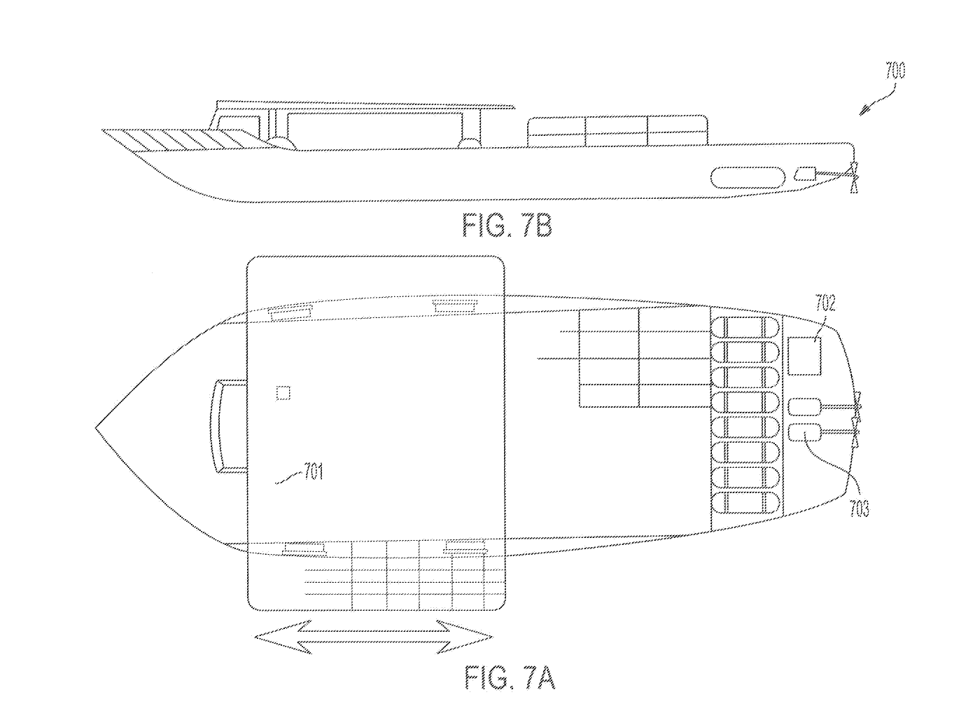

Shown in FIG. 7A is a top view of container ship 700 exemplifying the above. Shown in FIG. 7B is a side view of container ship 700 exemplifying the above. Solar panels 701 are used to capture sunlight energy to generate electricity. The electricity is connected to fuel cell/electrolysis 702 which converts water into hydrogen and oxygen. The hydrogen is then used to create electricity which powers electrical motors 703. The electrical motors are used to power the vessel by connection to the propellers. Hydrogen may be stored in a tank. The vessel could be powered by the solar panels in providing electricity to the electrical motors, or other times, for example, when solar exposure is inadequate, stored hydrogen may be used to generate electricity for the electrical motors 703 to power the propellers.

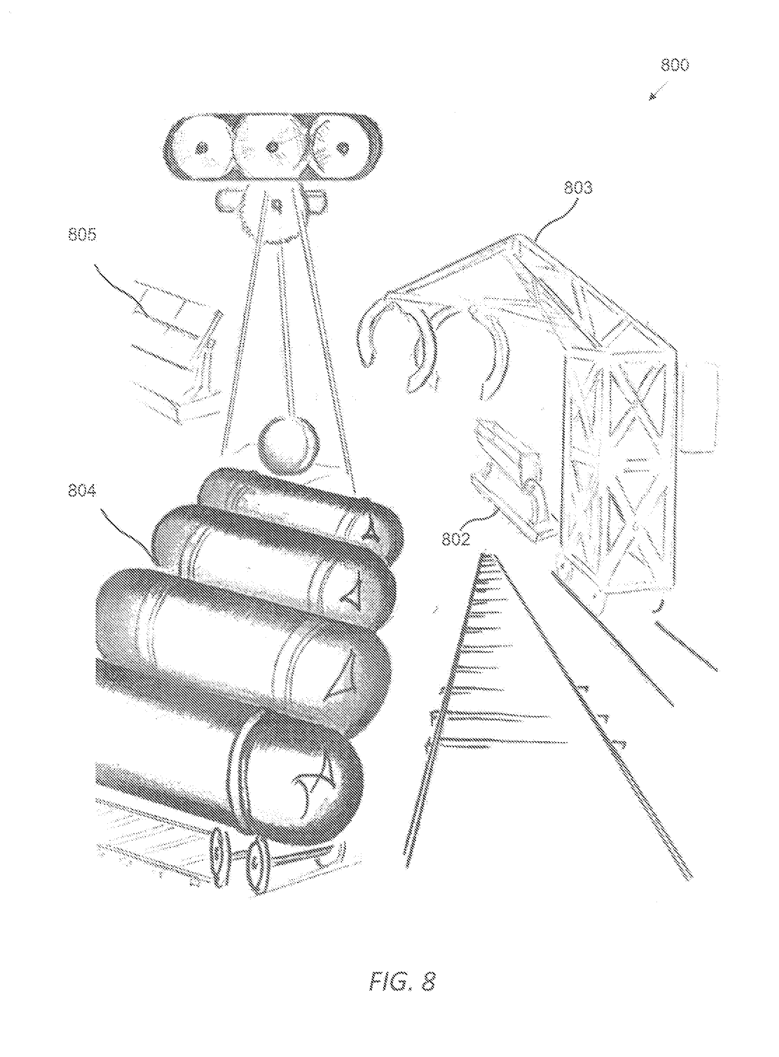

Shown in FIG. 8 is a method, device and system 800 disclosed herein that uses the Time Mill (discussed below), the parabolic solar oven 802, and a robotic crane 803, to achieve and store autonomous renewable energy. Hydrogen can be stored physically as either a gas or a liquid. Storage of hydrogen as a gas typically requires high-pressure tanks 804 (350-700 bar [5,000-10,000 psi.] tank pressure). Storage of hydrogen as a liquid requires cryogenic temperatures because the boiling point of hydrogen at one atmosphere pressure is −252.8 degrees C. Shown in FIG. 8 is the high-pressure storage of hydrogen in tanks. Fresh water is provided, such as drawn up from a well, and the electricity generated by the parabolic solar oven, solar cells 805, and/or the windmills of the Time Mill are utilized to bring about the electrolysis of this water. Hydrogen has the highest energy per mass of any fuel; however, its low ambient temperature density results in a low energy per unit volume, therefore requiring the development of advanced storage methods which have the potential for higher energy density. This enigma is solved by the extreme high pressure generated by the time mills pistons, the composite materials and strength conscious design of the storage vessels. As a train pulls up to the changing station, the two valves of the vessels “umbilical cord” are closed by the engineer, the robotic crane 803 picks up the spent hydrogen containers (not shown but similar to hydrogen containers 804) and moves them away for storage and refilling. Robotic crane 803 then picks up a fully charged hydrogen container 804 and places it on the rail car, the valves of the umbilical cord are reconnected by the engineer, and the process is completed. This same process is also applicable for the shipping industry, or other vessels or engines that can be powered by hydrogen.

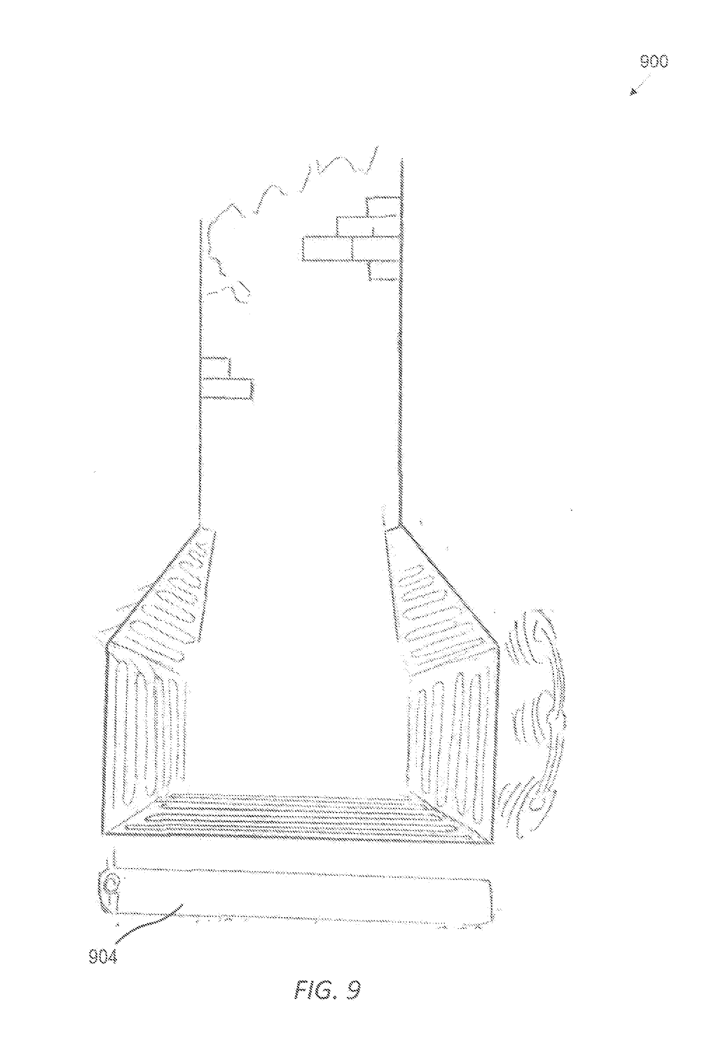

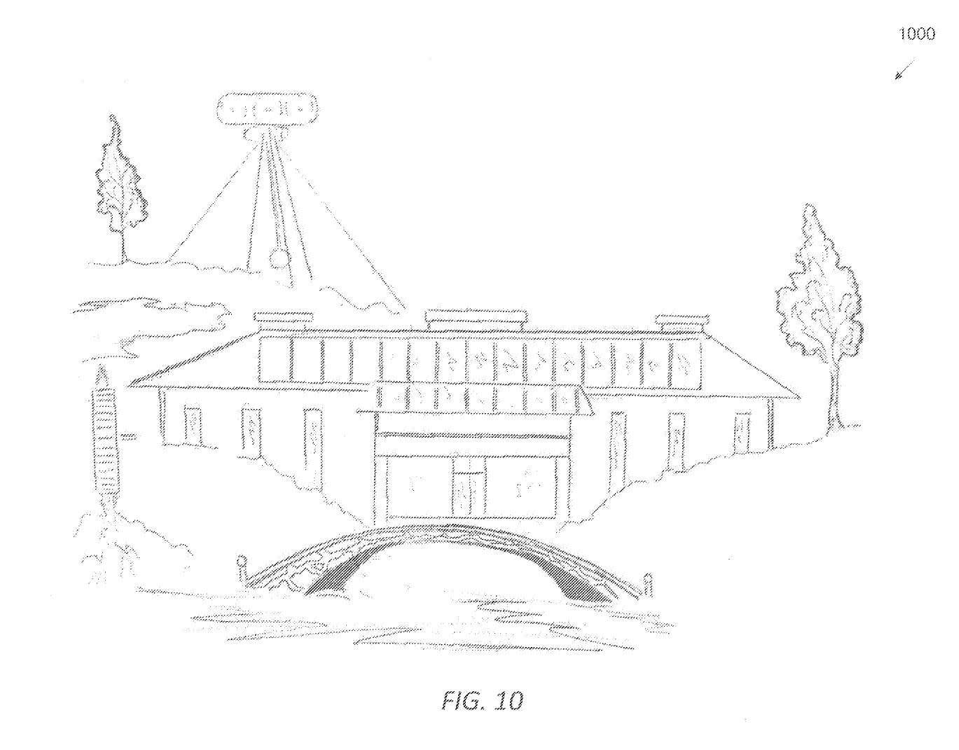

At his compound, Fairlane, Henry Ford had two generators, a main generator, and a backup generator in the event of mechanical difficulty. Fairlane illustrates using the disparity of water levels to turn an old fashioned water wheel and produce electricity. An altered view of Fairlane is shown in FIG. 10. The Time Mill (disclosed infra) in FIG. 10 can be used as a pump, and energy can be generated in the co-generative fireplaces (disclosed in FIG. 9). The co-generative fireplaces is a closed system in which a 6 cyl rotary steam engine is powered by the water injected into its boiler tube system and heat from the fireplace is used to heat the water to make steam. This expansive phenomenon can be used to compress air, create electricity outright, or pump water as is the case with the Fairlane Residence.

The future of clean, sustainable energy is not going to involve simply a car, a house, or a green workplace. It is going to be about how these entities interact with one another in a ubiquitous way and the devices capable of harvesting and amplifying the energy density of natural resources. The challenge is to not only make these devices efficient, resilient, and viable but also affordable. Until the manufacturability is perfected, the material science, and the economies of scale of any appliance associated with green power generation, some avenues to sustainability may seem cost prohibitive. However, when the purchase of these devices is viewed as a substitute for a power bill and fuel cost, funded under umbrella of a mortgage, and all applicable subsidies are applied, they begin to make very sound financial sense. These methods, devices and systems disclosed herein have been designed in a way that while they are integrated, it is also possible to purchase and use them separately because they will also function independently of one another.

As shown in FIG. 10, time mill can be used to pump water that is provided to water wheel which can be used to generate electricity. Additionally present at the altered Fairlane house, are cogenerative fireplaces and solar panels, each of which are also capable of providing electricity for use in the house. FIG. 9 shows an exemplary co-generative fireplace 900. Surrounding at least portions of fireplace 900 is a boiler tube system (not shown) in which the heat from the fireplace is transferred to liquid contained within the boiler system to form steam that powers steam engine (not shown). Steam engine (not shown) is used to produce energy for the structure containing fireplace 900. Pump (not shown) moves fluid (e.g., water) from condensation reservoir 904 through fluid connecting members (not shown) into the boiler system. Once the fluid is transformed into its gaseous phase, e.g., steam, the gas is provided to the steam engine to activate the steam engine to produce energy. The steam is transported back to the condensation reservoir by fluid connecting members (not shown). The co-generative fireplaces is a closed system in which a 6 cyl. rotary steam engine is powered by the water injected into its coils and is in turn translated into steam. This expansive phenomenon can be used to compress air, create electricity outright, or pump water as is the case with the Fairlane Residence.

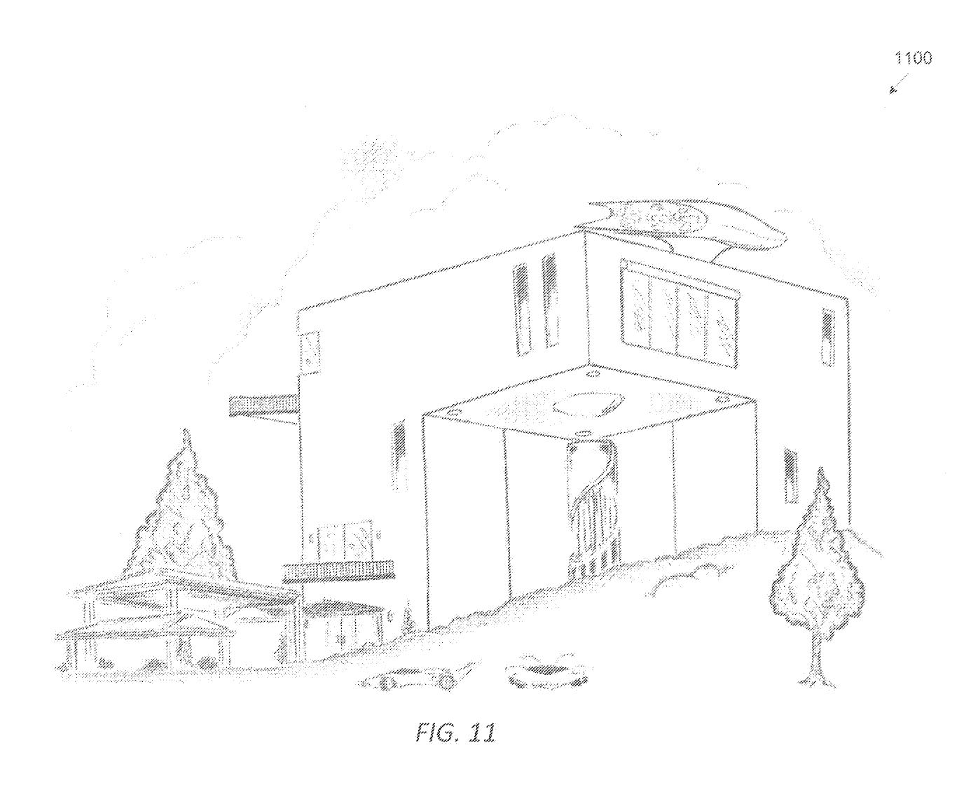

In the case of the Tesla residence, shown in FIG. 11, the entire structure is designed to mimic the weather prerequisites which facilitate a dust devil, or tornado. The large lens focuses the sun's energy down the cylinder which creates a hot spot. As this hot air begins to rise, it is replaced with the cooler air ensured by the shade of the dwelling's large soffit. The ensuing “twister” is assisted by the shape of the cylinder. As a result, the vertical windmill housed by the cylinder is turned and it drives a generator which powers the residence. The vertical windmill utilizes special magnetic bearings which reduce friction and the roof windmills augment the system when the sun is not shining. See FIG. 11. The residence (not shown) in its structure has lens (not shown) that focuses sunlight to heat the air present in cylinder (not shown), which encloses vertical windmill (not shown). The rising heated air, and optionally the sinking cooler air higher in the cylinder, cause vertical windmill (not shown) to turn, which can be used to drive a generator (not shown). The vertical windmill is connected to a generator by known components for activating and turning a generator. The generated energy can be used to provide power to the house. Other energy devices, such as windmills (not shown) may be present on the structure to provide additional energy to the house or vehicles connected to the house.

There are presently very few ways to store useful energy. Batteries, compressed air, and hydrogen cells are some of these, however, what is needed is an apparatus which operates intermittently as to more efficiently handle the task of harvesting clean, renewable energy. It is in this manner that a constant flow of resources is not requisite. Such a device would need to incorporate solar as well as wind power and have the capability of storing this energy to be available upon demand and to simultaneously be capable of producing work.

The Time Mill is a unique and useful component to augment any renewable energy system. Its functions are twofold in that it may be used to pump water autonomously (especially useful in third world countries) and it can also be used to compress air to later be run through a turbine or a rotary steam engine, either of which can in turn power a generator. Another example is to pump water uphill to be utilized to generate electricity or to provide other useful work. The pendulum is weighted and has an escapement so that its spring can be wound while it is operational. To further assist its operation, the pendulum passes through an electromagnetic field which it encounters at its bottom dead center position. This electromagnet is only operational during the B.D.C positioning to be hyper-conservative of electricity generated via the solar panels.

Just upward of the pendulums pivot point are two horizontally opposed pistons. The pendulums shaft functions as a lever and its pivot pin functions as a fulcrum. By utilizing this set up the swinging action of the device is translated into work and its weight and or length can be tailored to facilitate greater loads.

The windmills of the system can be set up to generate electricity, compress air, or pump water in accordance with the priorities of the system and the manner in which it is acclimated to exploit as much energy as possible.

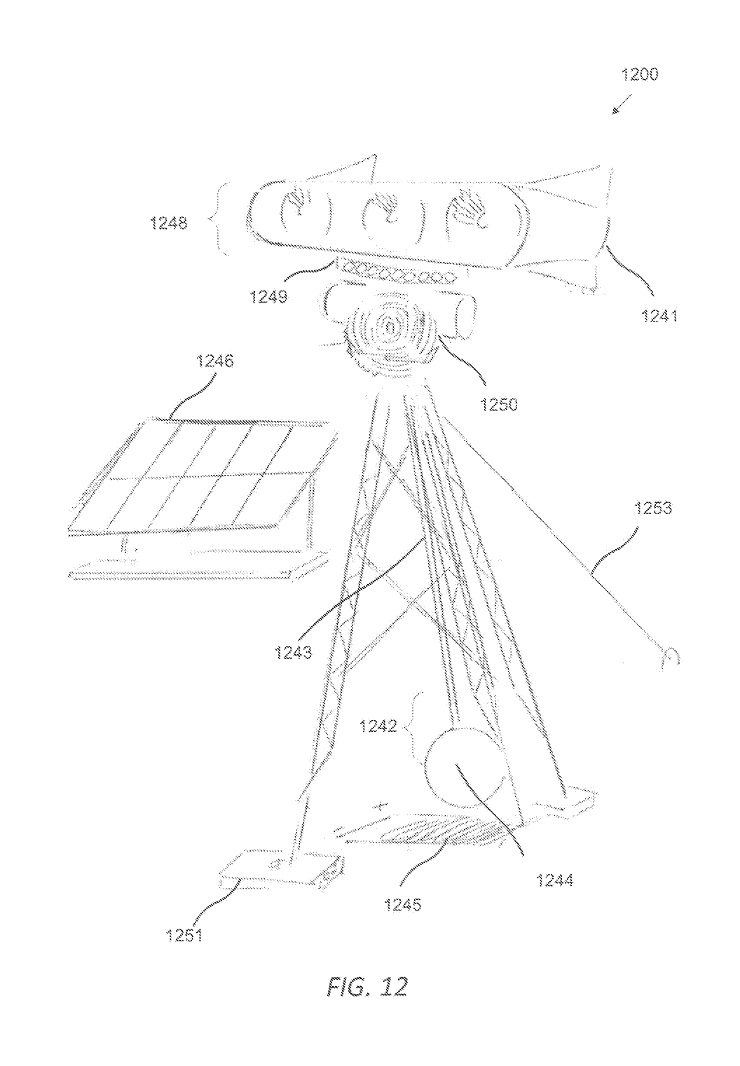

FIG. 12 shows a time mill 1200. Time mill 1200 comprises one or more windmills 1241 and a pendulum 1242 comprising shaft 1243 and a weight (also known as a bob) 1244. The pendulum weight 1244 is moved by an electromagnetic field 1245 placed in the path of the pendulum's weight's path of movement. Electromagnetic field 1245 is powered by an electrical current provided by an energy source, which is shown in FIG. 12 to be solar panel array 1246. The electromagnetic field is provided by an electrified pad or grid system, which are known to those of skill in the art, and it is connected to the energy source (e.g., solar array) by electrical connective members, for example, wires. Windmill 1241 is located above the pendulum pivot point 1248, and may ride on bearings 1249. The pendulum may comprise a spring 1250. The time mill is supported by support structures and may be anchored to the ground by footings 1251 and stability cables 1253.

Wind is not very prolific at lower heights. What is needed is a device which is powerful enough to be useful without having to be mounted on a massive tower, which may have detrimental issues during a high wind situation. In a commercial application, it is the consumer who pays to replace such a massive device. The solution is a mechanism capable of delivering usable amounts of energy at low altitudes, capable of storing such energy, automatically protect itself in the event of inclement weather capable of damaging it, and it must be cost efficient. A horizontal windmill realizes its efficiency because of the light weight of its many carbon fiber blades. These blades are curved much like a push lawnmower which allows them to grasp the wind and swirl it across the blades length. Integral also is the weight to area ratio which makes them function well even at low altitudes. The shape of the residence promotes the venturi effect utilizing the slope of the roof and the shape of the dwelling to force more air through the device's blades. This mechanism is capable of compressing air for later use, generating electrical current outright, or both of these functions. In the event of inclement weather or high winds, a sensor will deploy a protective cover to guard the device from excessive R.P.M.s which can damage or destroy it.

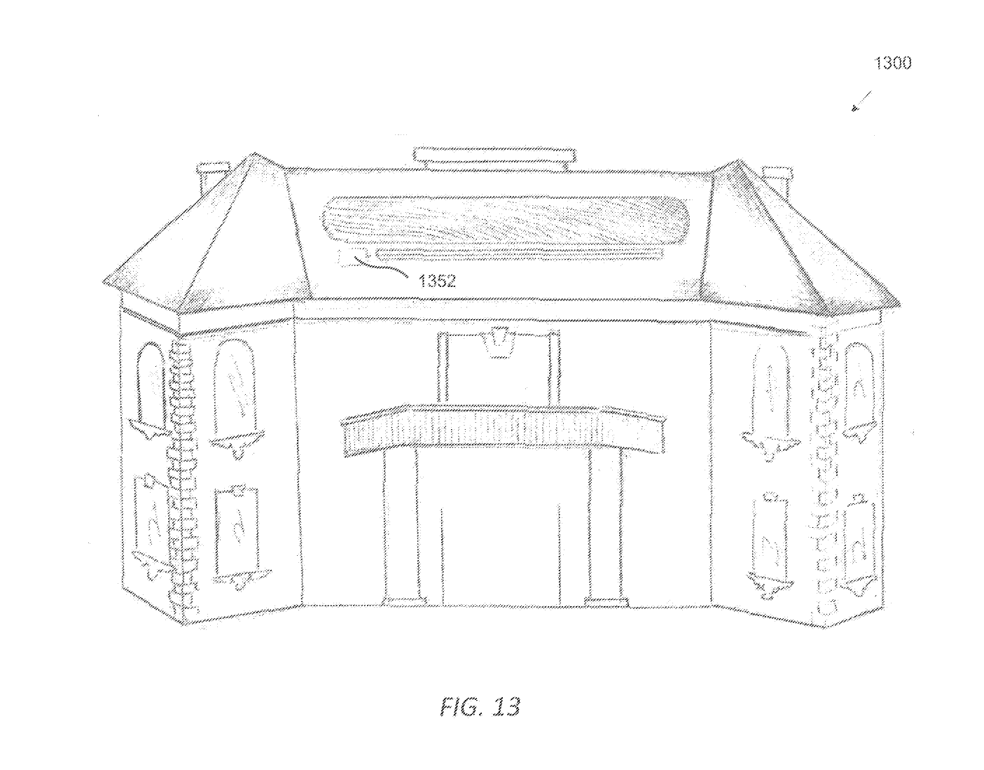

FIG. 13 shows a drawing of a residential structure 1300 powered by a horizontal windmill (not shown) using the slope of the roof and the venturi effect to move the vanes of windmill. Other components include motor 1352 which is powered by windmill and one or more wind sensors (not shown).

The electric vehicle is partially the solution to global warming, however, it is seldom realized that over the course of a dwelling's erection and its electrical usage, structures are actually a larger contributor to this phenomenon. Also it's rarely considered that most electricity, in the U.S. as well as globally, still comes from coal; the source is seldom considered. What is needed is electrical generation on a residential level which is powerful enough to recharge two electric vehicles, run all of the appliances and devices associated with a dwelling, and be capable of temporarily powering the residence in the event of a power outage. (this is in the event of people who don't have the entire system yet).

An Interactive Garage's primary job is to make wind energy and solar energy translate into recharging the lithium ion batteries for one's electric vehicle. Its secondary function is to temporarily power the residence in the event of a power outage. All of the devices disclosed herein are integral with one another and yet each may be utilized independently, depending on the amount of electricity needed.

In some applications it may be effective to generate hydrogen providing that a safe environment is achieved. In other applications the windmills are capable of turning into the wind with the aid of sensors and pivot pins. The parabolic solar oven is another facet of this system. It focuses the sun's energy towards its center and is further and marvelously augmented by the Fresnel lenses' focal points resting on stainless steel plates. These plates hold the heat more efficiently when the water is injected into the coils.

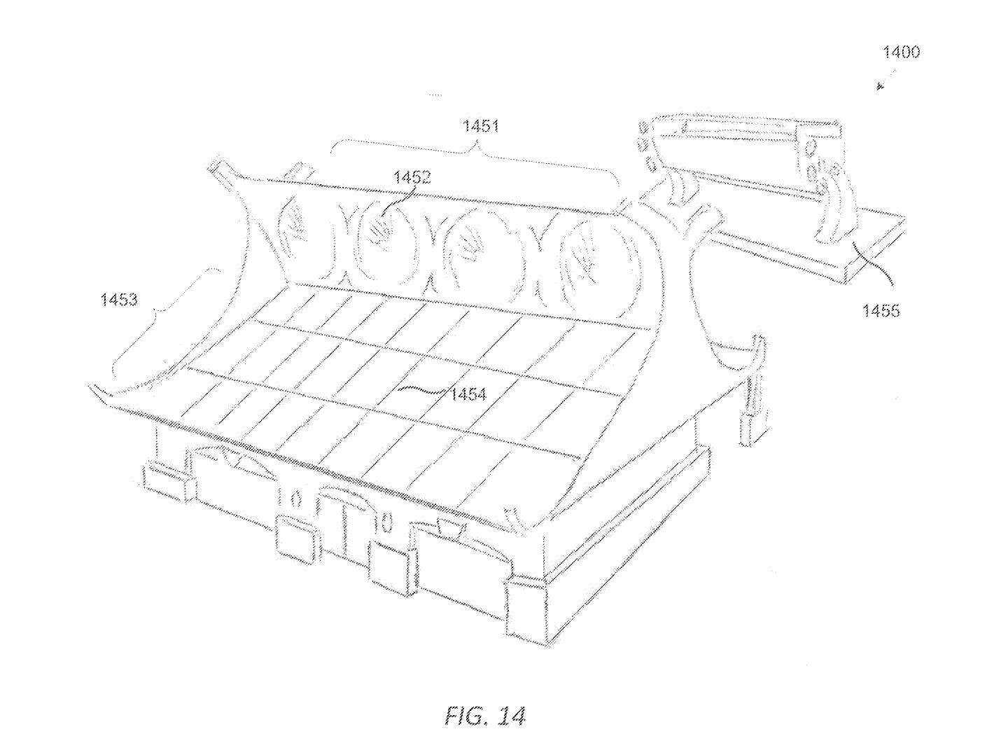

FIG. 14 shows a drawing of a structure 1400, such as an interactive garage, comprising multiple components disclosed herein. Windmill array 1451 comprises one or more individual windmills 1452. The roofline is shaped to enhance the Venturi effect. Structure 1400 comprises a solar panel array 1453 comprising a plurality of solar panels 1454. A parabolic solar oven 1455 may also be used to generate power for the structure or for vehicles housed by the structure.

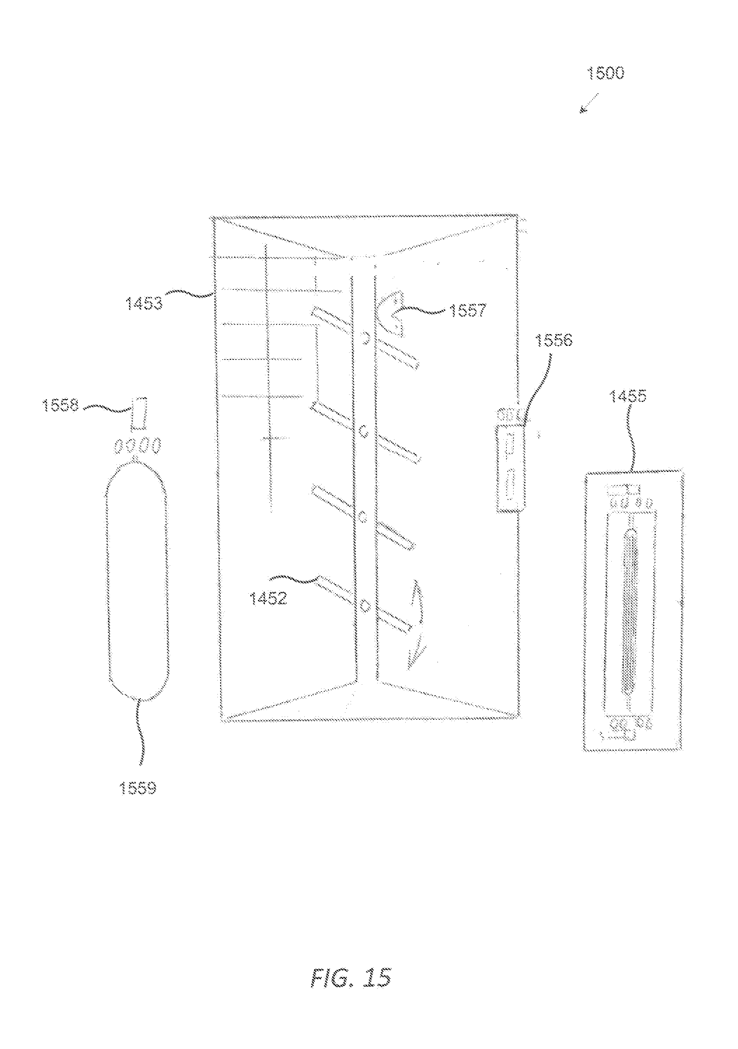

FIG. 15 shows a top view of the structure 1400 shown in FIG. 14. The directional windmills 1452 are capable of moving so as to have wind flow across and through the vanes of the windmills 1452. Structure 1400 may further comprise a co-generative fireplace 1556, as discussed above. A parabolic solar oven 1455 is shown, as are solar panel array 1453 on the roof of the structure. Within the structure, a Qi recharging station 1557 may be located. Electricity generated by an electric motor/generator 1558 connected to one or more of windmills 1452, solar panel array 1454 or solar oven 1455, may be used to power an air compressor so that compressed air is stored in a tank 1559, or may power one or more connected structures or recharge any vehicles connected. Components shown are connected by electrical conducting members and/or by mechanical connections to transfer energy.

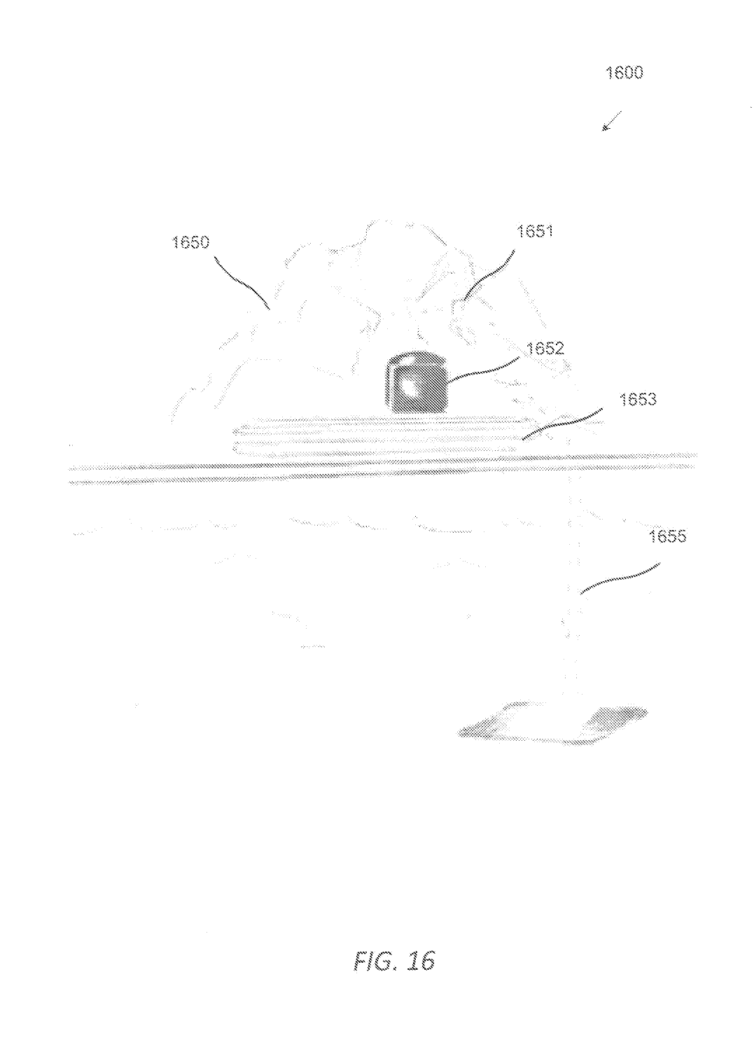

FIG. 16 shows components of systems and devices for methods of cooling a structure, such as a residence. Much of the energy use by a residence is to heat and cool it. The cooling process generally involves a closed system with the major components including, but not limited to, an evaporating coil, a condensing coil, and a compressor. These components of the system may be filled with a reactant, such as a substance which boils at less than the 212 degree F. boiling point of water and when allowed to boil or, as is the case, evaporate, it becomes cool, which is then used in cooling the building. The process is completed when the reactant or coolant is then compressed and run through the condensing coil where a 240 volt fan cools the compressor and condensing coil and the reactant, as the result of this, expands/evaporates again. Water is a much more effective coolant than air.

FIG. 16, the condensing aspect of the above-described cooling system is combined with the pool pump/filter of a body of water. By arranging the condensing coils in a faux waterfall in a way that the coils will have maximum contact with the cooling water, the 240 v fan is eliminated. All that is necessary then is the pool filter pump that was already going to be used.

The faux waterfall is fabricated, for example, from fiberglass, and the condenser coil is integral to the waterfall construction and a pump of adequate gpms is part of the system's performance. Over the course of the summer months, or other time period, a calculable savings of energy will be realized. Also, due to the superior cooling power of water, the compressor will last longer because it's been subjected to less heat, and the cooling efficiency of the entire system will be greater due to its superior ability to absorb and release heat.

As shown in FIG. 16, faux mountain 1650 facilitates the cooling of A/C condensing unit using pool pump 1651. Beautiful waterfalls are used to cool A/C compressor 1652 and condensing coils 1653 by using water from a body of water that is moved by connectors (pipes) 1655 from the filter. This eliminates the need for a fan to be used.

A problem with solar cells is that they are inefficient, cost prohibitive, ruin older roofs, don't last long enough to pay for themselves and do not provide enough electricity to facilitate one's lifestyle. In addition, the electricity must be stored in expensive batteries which must be replaced. What tomorrow's society needs is a system powerful enough to recharge one or more electric vehicles.

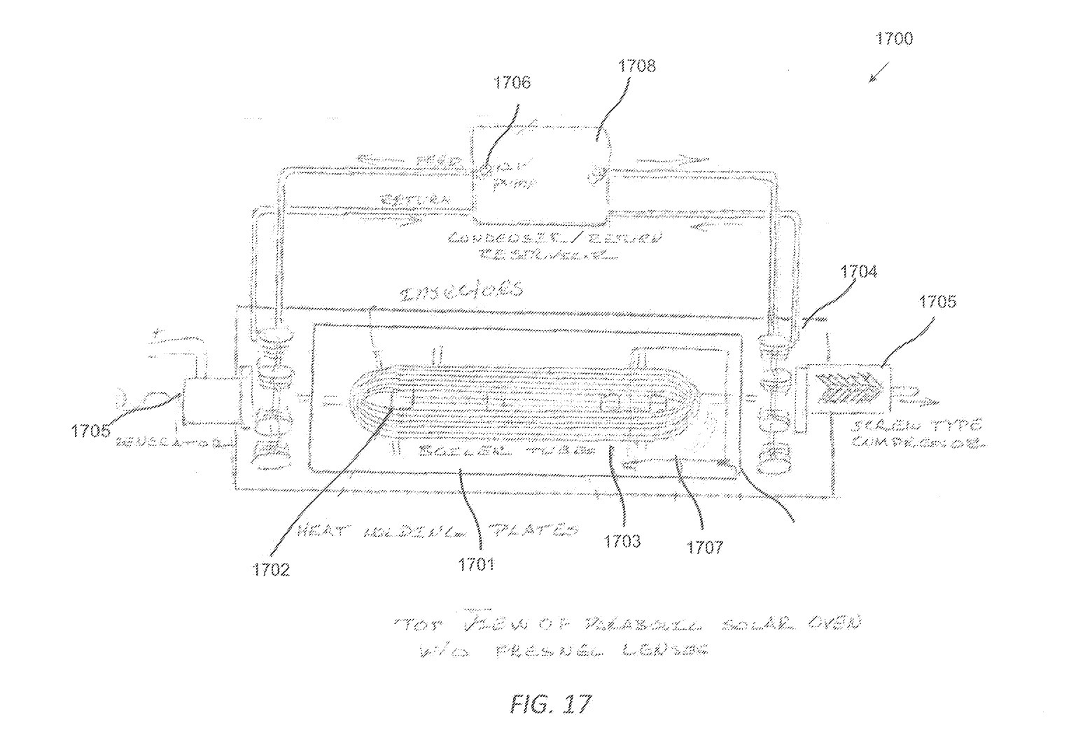

FIG. 17 shows a parabolic solar oven and optionally comprises one or more Fresnel lenses. Disclosed herein is a parabolic solar oven which heliotropes via photoresistors with the sun. To make this apparatus markedly more efficient, one or more Fresnel lenses may be attached and used to augment the focal point of the parabola. This solar oven is solid state, and may be made of any sturdy material, e.g., stainless steel, and is designed to be an appreciating appliance in that its structure will not need to be replaced and thus is worth repairing and replacing parts when necessary.

As the sun is focused upon the boiler tubes, not only by the parabola but also by the optional one or more Fresnel lenses, the internal portion of the boiler tubes will heat up to at least 212 degree F. temperature, the boiling point of water, and most optionally, higher. Distilled water is injected into the boiler tubes and the resulting steam is utilized to operate two steam engines located at each end of the oven. On one side of the oven, the work from a 6 cylinder rotary steam engine is converted to compressed air, or any other particular method of energy storage. On the other side of the oven, the work from the second steam engine is converted directly into electricity to be utilized immediately, for example in powering a residence, to charge an electric vehicle or to be stored in the vehicle's spare battery as outlined in previous descriptions of batteries.

FIG. 17 shows the top view of an exemplary solar oven, wherein one or more Fresnal lenses are shown as a square component for ease of understanding. As parabola 1701 begins to capture the sun's heat, one or more Fresnal lenses 1707 amplify and focus the solar energy on large steel plates 1702 designed to discourage the cooling effect of water that is injecting into boiler tubes 1703. The resulting steam is then introduced into rotary steam engines 1704 which can power, for example, either a screw type air compressor 1710 if pneumatics are the chosen vehicle or a generator 1705 if direct electricity is desired, or using two steam engines, both can be powered. The system is closed and water is introduced via a reservoir 1708 and a pump 1706 with feed and return lines to and from the one or more steam engines.

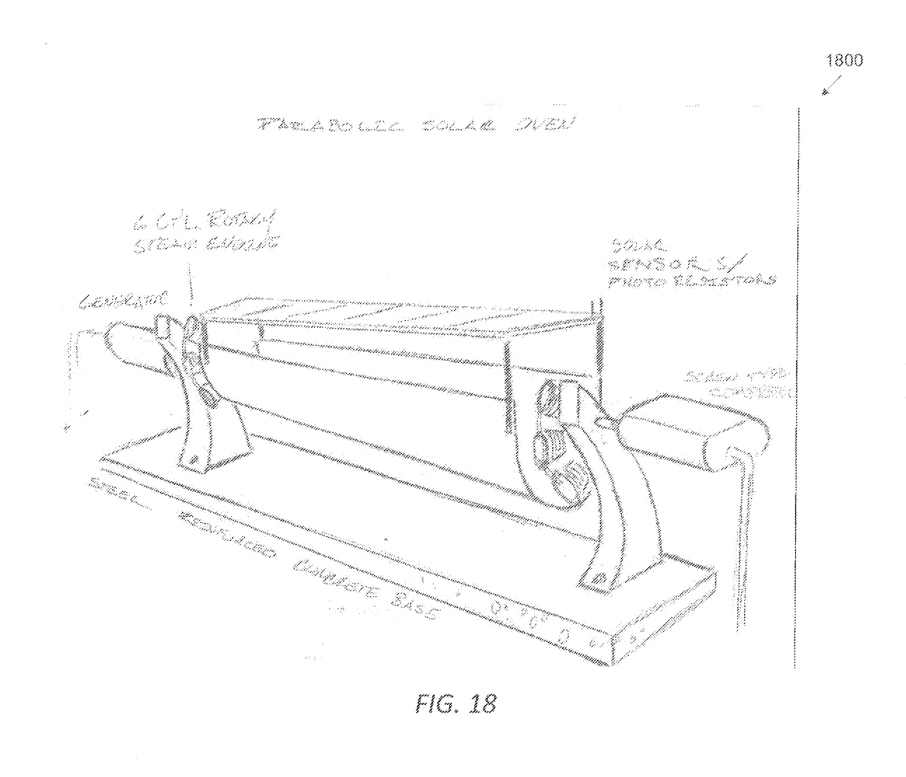

FIG. 18 shows a parabolic solar oven as disclosed having two steam engines, one on each end of the oven, wherein one steam engine is used to power a generator and the other steam engine is used to power an air compressor.

All references cited above are considered to be disclosed as fully and completely as if reproduced in their entirety.

Unless defined otherwise, all technical and scientific terms used herein have the same meanings as commonly understood by one of skill in the art to which the disclosed method and compositions belong. Although any methods and materials similar or equivalent to those described herein can be used in the practice or testing of the present method and compositions, the particularly useful methods, devices, and materials are as described. Publications cited herein and the material for which they are cited are hereby specifically incorporated by reference. Nothing herein is to be construed as an admission that the present invention is not entitled to antedate such disclosure by virtue of prior invention. No admission is made that any reference constitutes prior art. The discussion of references states what their authors assert, and applicants reserve the right to challenge the accuracy and pertinency of the cited documents. It will be clearly understood that, although a number of publications are referred to herein, such reference does not constitute an admission that any of these documents forms part of the common general knowledge in the art.

Throughout the description and claims of this specification, the word “comprise” and variations of the word, such as “comprising” and “comprises,” means “including but not limited to,” and is not intended to exclude, for example, other additives, components, integers or steps. In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step.

It is to be understood that the disclosed methods, devices and systems are not limited to specific methods or specific components, unless otherwise specified, and, as such, may vary. It is also to be understood that the terminology used herein is for the purpose of describing particular embodiments only and is not intended to be limiting.

Disclosed are materials, compositions, and components that can be used for, can be used in conjunction with, can be used in preparation for, or are products of the disclosed methods, devices and systems. These and other materials are disclosed herein, and it is understood that when combinations, subsets, etc. of these materials are disclosed that while specific reference of each various individual and collective combinations and permutation of these components may not be explicitly disclosed, each is specifically contemplated and described herein. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and an example combination A-D. This concept applies to all aspects of this application including, but not limited to, steps in methods of making and using the disclosed devices. Thus, if there are a variety of additional steps that can be performed it is understood that each of these additional steps can be performed with any specific embodiment or combination of embodiments of the disclosed methods, and that each such combination is specifically contemplated and should be considered disclosed.

While various aspects have been described in the context of a preferred embodiment, additional aspects, features, and methodologies of the claimed inventions will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed disclosure and their practical application so as to enable others skilled in the art to utilize the inventions and various embodiments and with various modifications as are suited to the particular use contemplated. Alternative embodiments will become apparent to those skilled in the art to which the claimed disclosure pertain without departing from their spirit and scope. Accordingly, the scope of the claimed disclosure is defined by the appended claims rather than the foregoing description and the exemplary embodiments described therein.

What is claimed is:

1. A power source, comprising:
(a) an internal combustion engine,
(b) a steam engine powered by steam generated from the heat produced by the internal combustion engine,
(c) a condenser to recycle the spent steam from the steam engine,
(d) said steam engine receives steam from boiler tubes surrounding at least a portion of the internal combustion engine,
(e) said steam engine is capable of transmitting force directly to a drivetrain and thus powering the vehicle alone after a warm-up period without the concurrent operation of the internal combustion engine,
(f) said internal combustion engine burns fuel and transmits power to a drivetrain to power the vehicle upon starting from cold,
(g) wherein after adequate steam pressure has been attained, operation of the internal combustion engine may cease and the steam engine is able to power the vehicle alone independently,
(h) wherein the relatively superior power and thermal efficiency of the steam engine as compared to the internal combustion engine allows for augmented overall fuel efficiency and reduced emissions,
(i) the steam engine is also capable of transmitting force to an electric motor/generator that is capable of powering an air compressor;
(j) wherein the air compressor compresses air so that compressed air is stored in a tank, and such compressed air can be released to provide power;
(k) the electric motor/generator is capable of sending electricity to and receiving electricity from one or more lithium batteries;
(l) the power source may further comprise an electrolysis unit for making hydrogen that is powered by either the electric motor/generator or by the one or more lithium batteries; wherein the hydrogen produced may be used to provide energy to the electric motor/generator.

2. The power source of claim 1, wherein the power source is used to power a vehicle.

3. The power source of claim 1, wherein the power source is used to power a vessel.

4. The power source of claim 1, wherein the power source is used to power a structure.

5. A method of generating energy comprising, activating the power source of claim 1.

6. A system for generating energy and power comprising the components of claim 1.
